(19) United States
(12) Patent Application Publication
(10) Pub. No.: US 2006/0193236 A1
(43) Pub. Date: Aug. 31, 2006

(54) Optical head unit and optical disc apparatus

(76) Inventors: Kazuo Watabe, Yokohama-shi (JP); Sumitaka Maruyama, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/363,873

(22) Filed: Feb. 28, 2006

(30) Foreign Application Priority Data
Feb. 28, 2005 (JP) 2005-054925

(51) Int. Cl. G11B 7/135

(52) U.S. Cl. 369/112.07

(57) ABSTRACT

To provide an optical head unit and an optical disc apparatus which is difficult to be influenced by interlayer crosstalk of recording layers and decreases a load of a signal reproduce system when reproducing and recording information from an optical disc having two or more recording layers, provide a diffraction optical element for forming an image on the light-receiving surface of a photodetector which receives a reflected laser beam reflected on first and second recording layers of an optical disc and outputs a corresponding signal, in a state that a component close to the center of a reflected laser beam reflected by an optical disc is polarized (diffracted).

### CROSS-REFERENCE TO RELATED APPLICATIONS

This application is based upon and claims the benefit of priority from Japanese Patent Application No. 2005-054925, filed Feb. 28, 2005, the entire contents of which are incorporated herein by reference.

### BACKGROUND

1. Field

One embodiment of the invention relates to an optical disc apparatus capable of reproducing information with minimized crosstalk when reproducing information from an optical disc with information recorded in two or more recording layers, and an optical head unit used in the optical disc apparatus.

2. Description of the Related Art

An optical disc used as an information recording medium is available in a read only type represented by CD and DVD-ROM, a write-once type represented by CD-R and DVD-R, and a recordable type used for an external memory of a computer and a recording/reproducing video (video recording).

Among optical discs of the DVD standard having more than two recording layers, a new standard disc called a super-high density next generation DVD (hereinafter, called an HD DVD) is required to make an intermediate layer thinner than that of a current DVD two-layer ROM disc (DVD-ROM) in order to increase recording capacity.

However, it is known that if an intermediate layer is made thin, interlayer crosstalk is increased. Further, the difference (magnification) between crosstalk generated in a first layer while reproducing a second layer and crosstalk generated in a second layer while reproducing a first layer, is greatly changed.

An optical disc apparatus includes a light transmitting system to radiate a laser beam with a fixed wavelength to a specified position on an optical disc (an information recording medium), a light receiving system to detect a laser beam reflected on the recording surface of an optical disc, a mechanism control (servo) system to control the operations of the light transmitting system and light receiving system, and a signal processing system which supplies recording information and an erase signal to the light transmitting system, and reproduces recorded information from a signal detected by the light receiving system.

The light transmitting system and light receiving system include a semiconductor laser element (laser diode), and an objective lens which condenses a laser beam from a laser diode onto the recording surface of an optical disc and captures a laser beam reflected by the optical disc. The position of an objective lens is controlled by a control signal obtained by a signal processing system, so as to be located almost at the center of the distance between a spot of a laser beam condensed at the focal position of an objective lens, optical disc and objective lens, and to be guided at almost the center of a record mark string where a spot of a laser beam condensed at the focal position of an objective lens is recorded on an optical disc, or a previously formed guide groove or a track.

Nowadays, in tracking to control the position of an objective lens to guide a spot of a condensed laser beam at the center of a record mark string recorded on an optical disc or a track, a differential push-pull (DPP) system is widely used for detection of a tracking error that detects a displacement of the laser beam spot from the center of the track.

It is disclosed by, for example, Japanese Patent Application Publication (KOKAI) No. 9-81942 proposes a DPP system, which gives a phase difference of π in left and right to a sub beam generated on the left and right of a center transmission light, and places the sub beam on the same track.

However, when applying a tracking error detection method of DPP system described in the above document to an HD DVD standard optical disc, the above-mentioned interlayer crosstalk in the intermediate layer is increased and a suitable reproduce signal is not obtained. Namely, interlayer crosstalk in a two-layer disc makes a DPP signal unstable.

Though the intensity of a sub beam used in the DPP system is increased to meet the demand for the increased optical disc recording speed, a sub beam generated from a laser beam used for recording information may reach the intensity level to erase a record mark recorded just before. Namely, information recording becomes unstable in an optical disc capable of being recorded at a high speed.

To detect all laser beams in the DPP system, detection elements of the number corresponding to the laser beams are necessary. This arises a problem of increased cost and noise.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a recording medium (optical disc) capable of being recorded, reproduced and erased information by using an optical disc apparatus and an optical head unit according to an embodiment of the invention;

FIG. 2 is an exemplary diagram showing an example of an optical disc apparatus and an optical head unit according to an embodiment of the invention;

FIG. 3 is an exemplary diagram showing a diffraction grating incorporated in the optical head unit shown in FIG. 2, and the relationship between an optical beam diffracted by the diffraction grating and a track of an optical disc according to an embodiment of the invention;

FIG. 4 is an exemplary diagram showing the relationship between a diffraction area and a non-diffraction area (simple transmission area) of a diffraction optical element incorporated in the optical head unit shown in FIG. 2 according to an embodiment of the invention;

FIG. 5 is an exemplary diagram showing the relationship between a diffraction optical element incorporated in the optical head unit shown in FIG. 2 and an optical beam forming an image in a photodetector according to an embodiment of the invention;

FIG. 6 is an exemplary diagram showing an example of a signal detection system and a signal processing system incorporated in the optical head unit shown in FIG. 2 according to an embodiment of the invention;

FIG. 7 is an exemplary graph showing an example of a TES output obtained by the signal processing system (arithmetic unit) shown in FIG. 6 according to an embodiment of the invention;

FIGS. 8A to 8C are exemplary diagrams explaining the principle of generating an interlayer crosstalk in a two-layer optical disc shown in FIG. 1 according to an embodiment of the invention;

FIG. 9 is an exemplary diagram showing another embodiment of a diffraction grating incorporated in the optical head unit shown in FIG. 2, and the relationship between an optical beam diffracted by the diffraction grating and a track of an optical disc according to an embodiment of the invention;

FIG. 10 is an exemplary diagram showing an example of a signal detection system and a signal processing system used when the diffraction grating shown in FIG. 9 is incorporated in the optical head unit shown in FIG. 2 according to an embodiment of the invention;

FIG. 11 is an exemplary graph showing an example of a TES output obtained by the signal processing system (arithmetic unit) shown in FIG. 10 according to an embodiment of the invention;

FIG. 12 an exemplary diagram showing a third embodiment of a diffraction grating incorporated in the optical head unit shown in FIG. 2, and the relationship between an optical beam diffracted by the diffraction grating and a track of an optical disc according to an embodiment of the invention;

FIG. 13 is an exemplary diagram showing an example of a signal detection system and a signal processing system used when the diffraction grating shown in FIG. 12 is incorporated in the optical head unit shown in FIG. 2 according to an embodiment of the invention;

FIG. 14 is an exemplary graph showing an example of a TES output obtained by the signal processing system (arithmetic unit) shown in FIG. 13 according to an embodiment of the invention;

FIG. 15 is an exemplary diagram showing a modification of the signal processing system (arithmetic unit) shown in FIG. 6 according to an embodiment of the invention;

FIG. 16 is an exemplary diagram showing a modification of the signal processing system (arithmetic unit) shown in FIG. 10 according to an embodiment of the invention; and

FIG. 17 is an exemplary diagram showing a modification of the signal processing system (arithmetic unit) shown in FIG. 13 according to an embodiment of the invention.

### DETAILED DESCRIPTION

Various embodiments according to the invention will be described hereinafter with reference to the accompanying drawings. In general, according to one embodiment of the invention, an optical head unit and an optical disc apparatus which is difficult to be influenced by interlayer crosstalk of recording layers and decreases a load of a signal reproduce system when reproducing and recording information from an optical disc having two or more recording layers, provide a diffraction optical element for forming an image on the light-receiving surface of a photodetector which receives a reflected laser beam reflected on first and second recording layers of an optical disc and outputs a corresponding signal, in a state that a component close to the center of a reflected laser beam reflected by an optical disc is polarized (diffracted).

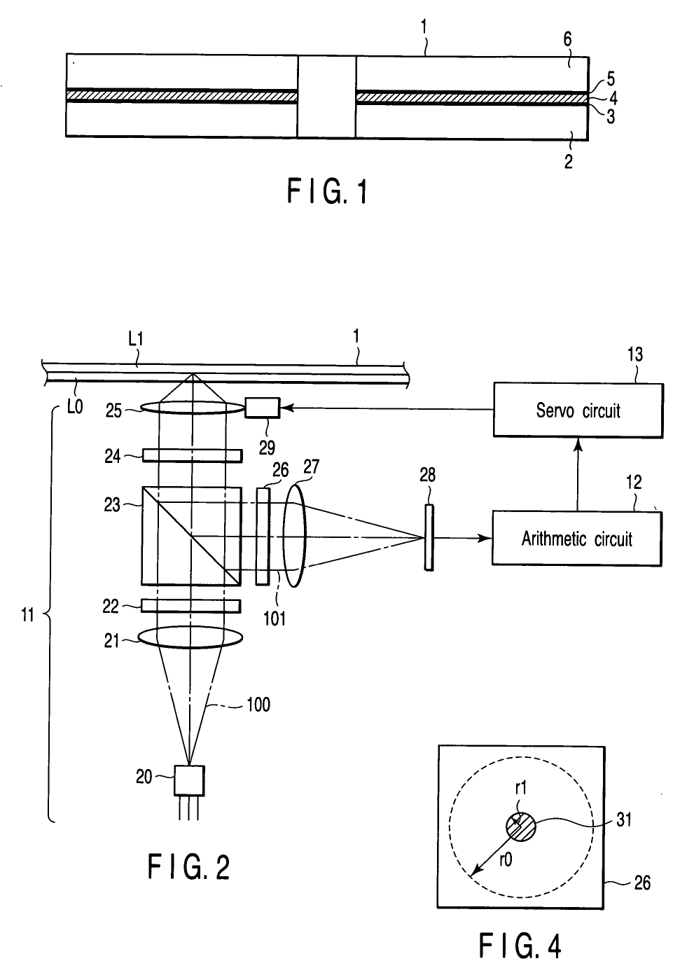

According to an embodiment, FIG. 1 is a schematic diagram showing an example of a configuration of an optical disc suitable for recording and reproducing information by an optical head unit of the invention explained hereinafter with reference to FIG. 2.

As shown in FIG. 1, an optical disc (recording medium) 1 has a first information recording layer 3 including a phase-change recording film, on a first substrate 2 made of polycarbonate, for example.

The first information recording layer 3 is laminated by an intermediate layer 4 having a fixed transmissivity to the wavelength of a laser beam outputted from a semiconductor laser unit 20 of an optical head unit 11. The intermediate layer 4 is laminated by a second information recording layer 5. The intermediate layer 4 is usually made of adhesive or ultraviolet ray hardened resin. The second information recording layer 5 is covered by a second substrate 6 made of polycarbonate, for example.

In the optical disc 1, the information recording layers 3 and 5 may be a read only layer having a reflection film made of metal, or a recordable/readable layer composed of a phase-change film. One of the recording layers 3 and 5 may be a read only layer, and the other may be a recordable/readable layer.

As described above, the optical disc 1 can be formed either by laminating the first substrate 2 to second substrate 6 in order, or by bonding two substrates having the recording layer 3 (or 5) formed to a fixed thickness to one side of the substrate 2 (or 6) by using adhesive material to be opposite to each other. The thickness of the substrate with an information recording layer formed on one side is approximately 0.6 mm, and the thickness of the whole optical disc 1 is approximately 1.2 mm (reference substrate thickness).

The above optical disc 1 is a so-called one-side two-layer disc. The first information recording layer 3 is translucent having a fixed transmissivity to the wavelength of a laser beam output from the semiconductor laser unit 20. Therefore, the first information recording layer 3 can reflect a certain amount of light and transmit the residual amount of light. Thus, when light is applied to the substrate 2, the optical disc 1 can record and reproduce information on/from one of the information recording layers 3 and 5 by adjusting the focus to one of the first recording layer 3 and second recording layer 5 (by controlling the position of an objective lens 24 so that the distance from the objective lens 24 to the optical disc 1 with respect to the position where a laser beam 100 is condensed by the convergence given to a laser beam 100 through the objective lens 24, becomes identical to one of the recording layers 3 and 5).

While information is being reproduced from one of the information recording layers 3 and 5, the intermediate layer 4 functions to optically out off a leak (crosstalk) of information from the other recording layer 5 or 3. In this sense, the information recording layers 3 and 5 of a two-layer disc is desirably separated as far as possible, and the thickness of the intermediate layer 4 is desirably as thick as possible. However, in this case, a load is applied to the optical system used for recording and reproduce of information.

Namely, when the thickness from the surface of the substrate 2 to the center of the intermediate layer 4 is defined as a load of an objective lens explained below with reference to FIG. 2, an aberration is generated by a thickness error for the half of the thickness of the intermediate layer 4 even when recording or reproducing information in/from either information recording layer 3 or 5.

Therefore, from the viewpoint of aberration of the recording/reproduce optical system, the thin intermediate 4 is better. Namely, the thickness of the intermediate layer 4 is determined by a trade-off point between the crosstalk over the information recording layers 3/5 and the aberration of the recording/reproduce optical system.

FIG. 2 is a schematic diagram showing an example of an optical head unit for recording and reproducing information on/from an optical disc shown in FIG. 1, and an optical disc apparatus which includes the optical head unit.

As shown in FIG. 2, the optical head unit 11 has a semiconductor laser (light source) 20 to output a purple optical beam or laser beam of 400 nm to 410 nm, for example. The laser beam wavelength is preferably 405 nm.

Light (optical beam) 100 emitted from the semiconductor laser light source 20 is collimated by a collimator lens 21 to be a parallel light, and guided to a 3-beam diffraction grating 22 used for obtaining a tracking error signal by a differential push-pull (DPP) system explained later. The diffraction grating 22 generates three beams of 0th-order (non-diffracted light), +1st-order diffraction light and −1st-order diffraction light from the light 100. The 0th-order light is called a main beam, and the ±1st-order diffraction light is called a sub beam.

The optical beams (3 beams) passed through the diffraction grating 22 are passed through a polarization beam splitter 23, λ/4 plate 24, and guided to the recording surface of the optical disc 1 by the objective lens 25. As shown in FIG. 1, the optical disc 1 has the first recording layer 3 and second recording layer 5, and the optical beam 100 guided to the optical disc 1 is condensed on one of the first and second recording layers 3 and 5 by the convergence given by the objective lens 25 according to the distance from the objective lens 25 to the optical disc 1.

The laser beam 100 condensed on the recording layer of the optical disc 1 is reflected by the recording layer, returned to the objective lens 25 as a reflected laser beam 101, and returned to the polarization beam splitter 23 through the λ/4 plate.

The reflected laser beam 101 returned to the polarization beam splitter 23 is reflected on the polarizing surface of the polarization beam splitter 22, and applied to a diffraction optical element for detection 26 having a fixed diffraction pattern.

The reflected laser beam passed through the diffraction optical element 26 is focused to form an image on the light-receiving surface of a photodetector 28, as a convergent light with a beam spot size corresponding to a focal distance defined by the convergence given by the condenser lens 27.

The light-receiving surface of the photodetector 28 is usually divided into several areas, and outputs a current corresponding to the light intensity of the optical beam received by each light-receiving area. The current output from each light-receiving area of the photodetector 28 is converted into a voltage by a not-shown I/V amplifier, and processed by an arithmetic circuit 12 to be usable for a HF (reproduce) signal, a focus error signal and a tracking error signal. A HF (reproduce) signal is output to a temporary storage or an external storage, for example, in being converted into a specified signal format not described in detail, or through a specified interface.

The signal obtained by the arithmetic circuit 12 is supplied also to a servo driver 13 and used to generate a focus error signal for changing the position of the objective lens 25, so that an optical spot formed in a specified size at the focal position of the objective lens 25 becomes identical to the distance between the objective lens 25 and one of the corresponding recording layers 3 and 5 of the optical disc 1. The focus error signal is used to obtain a focus control signal for changing the position of an actuator 29 which displaces the position of the objective lens 25. The focus control signal generated based on the focus error signal is supplied to the actuator 29. Thus, the objective lens 25 held by the actuator 29 is optionally moved in the direction close to or separated away from the information recording layer 3 or 5 of the optical disc 1 (in the vertical direction in FIG. 1).

The signal obtained by the arithmetic circuit 12 is also supplied to a servo driver 13, and used to generate a tracking error signal for changing the position of the objective lens 25, so that an optical spot of the optical beam 100 condensed at the focal position of the objective lens is guided at substantially the center of a record mark string recorded on the optical disc 1, or a previously formed guide groove or a track. The tracking error signal is used to obtain a tracking control signal for moving the actuator 29 which displaces the position of the objective lens 25. The tracking control signal generated based on the tracking error signal is supplied to the actuator 29. Therefore, the objective lens 25 held by the actuator 29 is optionally moved in the direction crossing the radial direction of the information recording layer 3 or 5 of the optical disc 1 or a track or a record mark string.

Namely, the objective lens 25 is controlled by the servo driver 13, so that the size of the optical spot condensed on the track or record mark string formed on the optional recording layer 3 or 5 of the optical disc 1 by the objective lens 25 becomes smallest on the recording layer, in its focal distance.

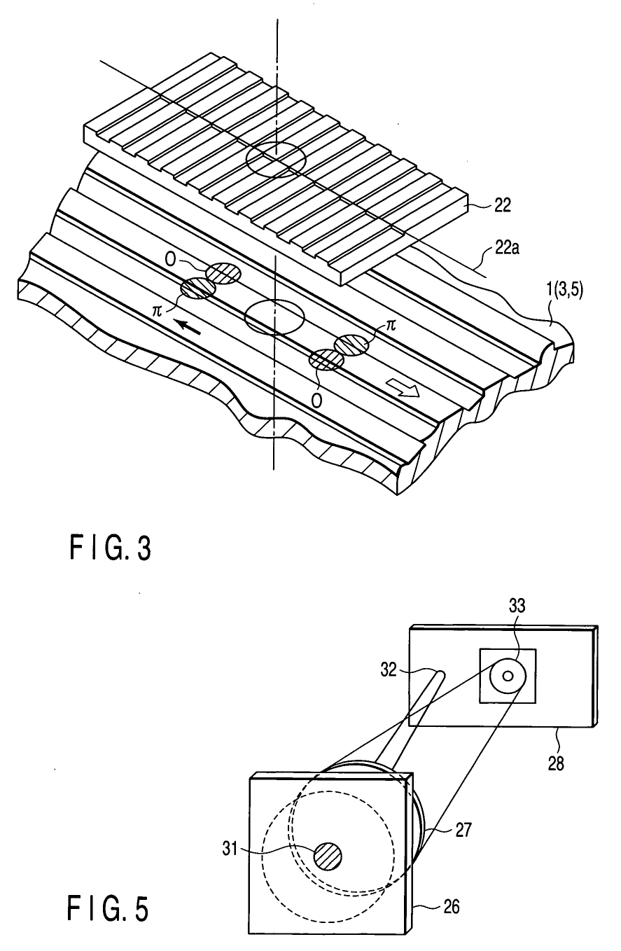

FIG. 3 shows the principle that three beams are obtained from the laser beam 100 collimated by the collimator lens 21, by the diffraction grating 22. FIG. 3 explains the relation ship between the diffraction grating 22 and a track (guide groove) or a record mark string of the optical disc 1, and the interval and size are of course different from the actual ones. A track (guide groove) of the optical disc 1 is actually spiral or concentric, but in a broad sense, substantially a straight line. The diffraction grating 22 is binary type, for example.

As shown in FIG. 3, the diffraction grating 22 is divided into two parts by a partition line 22a defined parallel to the tangential direction of a track (or a record mark string), in the state projected on a track (or a record mark string) formed on the recording layer 3 (5) of the optical disc 1. The diffraction grating 22 is a transparent plate having concave and convex grooves (gratings) formed at substantially constant intervals in the direction orthogonal to the partition line 22a. The phase of the concave and convex grooves (gratings) is inverted between the cells divided into two parts by the partition line 22a.

In FIG. 3, a diffraction light (±1st-order diffraction light or a sub beam) diffracted by two cells divided by the partition line 22a of the diffraction grating 22 is a luminous flux with the phase displaced by π. Light passing through the diffraction grating 22, or a non-diffracted light or main beam (hereinafter, called a 0th-order light to discriminate from a ±1st-order diffraction light) is condensed at substantially the center of a track as an optical spot with a fixed size defined by the condensing characteristic of the objective lens 25.

As seen from FIG. 3, a ±1st-order diffraction light (sub beam) generated by the diffraction grating 22 appears in the longitudinal direction of a track centering around a main beam (0th-order light), or the front-rear direction when the optical disc 1 is rotated. In this time, a sub beam is placed on the same track as a main beam. In other words, the interval (pitch) and depth (diffraction angle) of the concave convex grooves of the diffraction grating 22 have a diffraction pattern capable of giving a fixed diffraction to the optical beam 100 sent from the light source 20 to the objective lens 25, so that a sub beam is generated before and after a main beam as a pair on the same track. Therefore, by using the diffraction grating 22 shown in FIG. 3, three beams for DPP can be obtained even from an optical disc with a different track pitch.

A sub beam is a beam diffracted by the diffraction grating 22, and as described above, the luminous flux is divided into two parts having a phase difference of π to each other. A sub beam is used for detection of a tracking error by the differential push-pull system as described later. A main beam is used for recording and reproduce of information.

The diffraction optical element 26 is an optical element having a predetermined diffraction pattern formed by a hologram on a glass plate with a fixed thickness, for example, and separates the central part and peripheral part of the luminous flux of a reflected light 101. FIG. 4 schematically shows the structure of the diffraction optical element 26. The doted line indicates the outside diameter of a luminous flux entering the diffraction optical element 26. The radius of this outside diameter circle is r0. The diffraction optical element 26 has a diffraction pattern 31 only in a central circular area r1, and can diffract a luminous flux applied to this area in a fixed direction. A luminous flux passing through the other areas (radius r0 to r1) than this circular area is passed through without being diffracted.

FIG. 5 explains the function of the diffraction optical element 26 in details.

A reflected optical beam 101 entering the diffraction optical element 26 is divided into an optical beam diffracted by the central diffraction pattern 31 and a passing beam to pass through the peripheral part, and applied to the condenser lens 27. Each optical beam is converted to a convergent luminous flux by the condenser lens 27, and focused as an image at a fixed position on the light-receiving surface of the photodetector 28. As a result, on the light-receiving surface of the photodetector 28, a condense spot 32 by the diffraction optical beam diffracted by the central diffraction pattern 31 of the diffraction optical element 26 is radiated at a position spaced far from a condense spot 33 by the non-diffracted optical beam passed through the peripheral part.

Namely, the central part and peripheral part of the luminous flux entered to the diffraction optical element 26 can be separated on the photodetector 28. FIG. 5 shows only one luminous flux entering the diffraction optical element 26 for simplifying explanation. In this embodiment, three beams of 0th-order light and ±1st-order diffraction light are applied to the diffraction optical element 26.

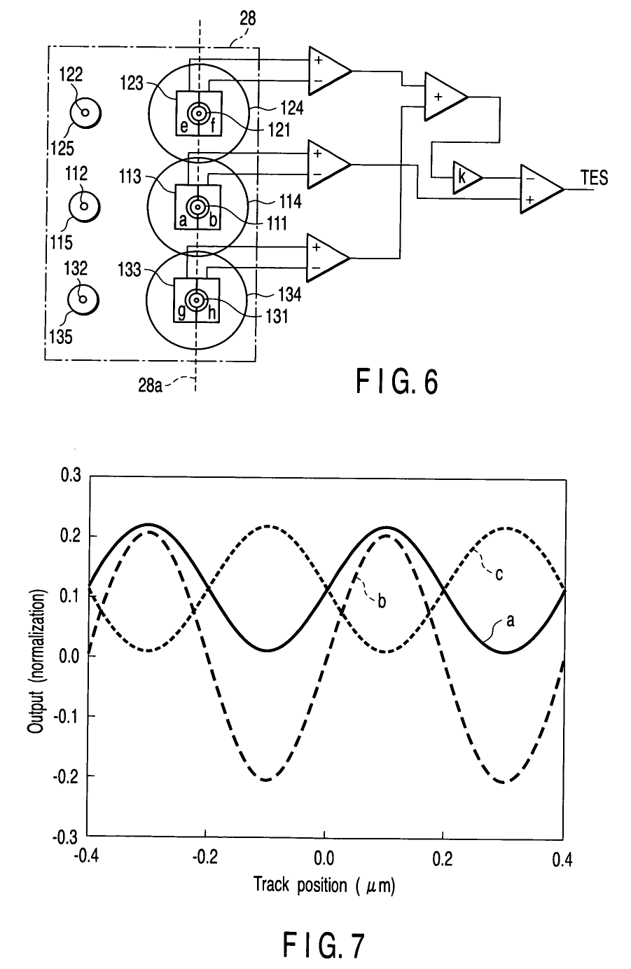

Next, explanation will be given on a condense spot (0th-order light and ±1st-order diffraction light) radiated to the light-receiving part of a photodetector with reference to FIG. 6.

FIG. 6 shows the state that condense spots 111 and 112 corresponding to a main beam (0th-order light), condense spots 121 and 122 corresponding to a sub beam (−1st-order diffraction light), and condense spots 131 and 132 corresponding to a sub beam (+1st-order diffraction light) are condensed on respective light-receiving areas of the photodetector 28. The condense spots 121 and 122 are arbitrarily called a −1st-order diffraction light. Of course, they may be called a +1st-order diffraction light.

In FIG. 6, the condense spots 112, 122 and 132 are spots of the beams diffracted by the central diffraction pattern 31 of the diffraction optical element 26, and the condense spots 111, 121 and 131 are spots of the beams passing through the peripheral part.

The photodetector 28 is provided with two-divided light-receiving parts 113, 123 and 133 corresponding to the condense spots 111, 121 and 131. The two-divided light-receiving parts are divided into two parts by a partition line 28a (corresponding to the partition line 22a in FIG. 3) corresponding to the direction parallel to the track on the optical disc 1.

Reference characters a and b indicate the left and right cells of the two-divided light-receiving part 113, e and f indicate the left and right cells of the two-divided light-receiving part 123, and g and h indicate the left and right cells of the two-divided light-receiving part 133.

Each cell outputs a current corresponding to the light intensity of an optical beam radiated (condensed) to that cell. The output current is converted to a voltage by a not-shown I/V conversion amplifier, and becomes a voltage output.

Assuming the voltage output signals obtained from the cells a, b, e to h to be Sa, Sb, Se to Sh, a tracking error signal TES as a DPP signal is obtained by the following equation in the arithmetic circuit in FIG. 6.
TES=(Sa−Sb)−k(Se−Sf+Sg−Sh)

According to the DPP (TES) signal, when the objective lens 25 is shifted in the direction vertical to a track, a signal excluding a usually generated offset is obtained.

FIG. 7 shows an example of TES output obtained in the signal processing system (arithmetic unit) shown in FIG. 6.

FIG. 7 shows the result of calculation assuming that the wavelength λ of an optical beam emitted from the light source 20 is 405 nm, the numerical aperture NA of the objective lens 25 is 0.65, the track pitch of the optical disc 1 is 0.4 μm and k=0.5, and the lens shift of the objective lens 25 is 150 μm.

As seen from FIG. 7, the ordinary push-pull signal Sa−Sb indicated by the curve a generates a large offset, and does not cross a point 0. Likewise, the signal Se−Sf or Sg−Sh indicated by the broken line curve c does not cross a point 0.

Contrarily, the TES as an output obtained by the arithmetic circuit shown in FIG. 6 includes little offset as indicated by the broken line curve b. This proves that the optical head unit of this embodiment can provide a DPP signal capable of discriminating a point 0 exactly.

Referring again to FIG. 6, the condense spots 114, 115, 124, 125, 134 and 135 condensed on the light-receiving surface of the photodetector 28 indicate the condense spots of crosstalk light of 0th-order light (non-diffracted light), +1st-order diffraction light and −1st-order diffraction light.

Crosstalk light indicates, in this case, a condense spot of a reflected light beam that is radiated to the information recording layer 3 before the information recording layer 5 in the defocused state and partially reflected and returned to the objective lens 25, among the beams radiated to the information recording layer 5 of the optical disc 1. The reflected light from the object information recording layer (the information recording layer 5) on the optical disc 1 is called a signal light for convenience's sake. When recording or reproducing in/from the information recording layer 3 of the optical disc 1, a signal light is a beam reflected on the information recording layer 3, and a beam reflected on the information recording layer 5 is crosstalk light.

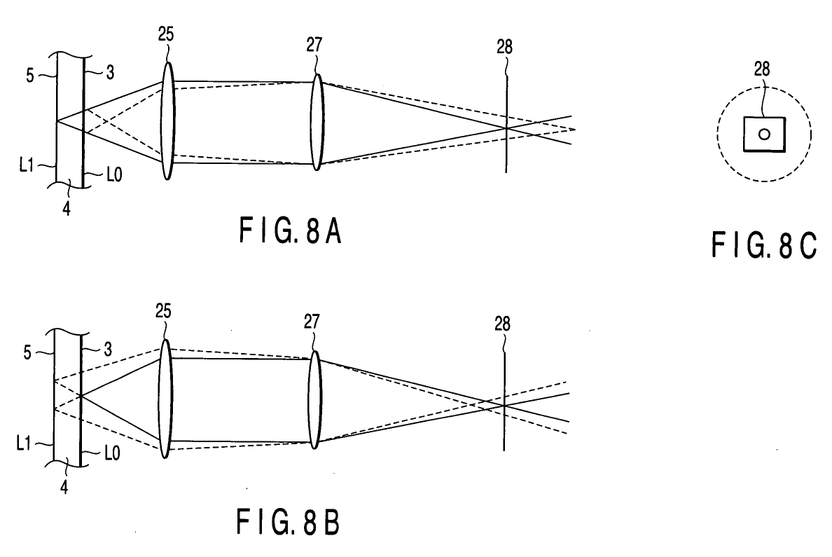

Now, explanation will be given on crosstalk light when recording or reproducing on/from a two-layer optical disc with reference to FIGS. 8A to 8C. FIGS. 8A to 8C extract and schematically shows the light-receiving optics of the optical disc apparatus shown in FIG. 2, or a reflected light path. FIG. 8A shows the case that the information recording layer 5 (L1) far from an objective lens is recorded or reproduced. FIG. 8B shows the case that the information recording layer 5 (L0) near an objective lens is recorded or reproduced.

First, FIG. 8A will be explained.

The optical beam 101 (solid line) reflected from the information recording layer 5 (L1) is passed through the objective lens 25 to become parallel light, condensed by the condenser lens 27, and focused near the photodetector 28. The photodetector 28 detects signal light from the object information recording layer (L1).

At the same time, a certain amount of light is reflected on the information recording layer 3 (L0) in the optical disc 1 (indicated by the broken line in the drawing). This is crosstalk light.

Unlike the signal light beam indicated by the solid line, the crosstalk light does not become parallel light after passing through the objective lens 25, and becomes diffused light, and then defocused by the condenser lens 27, and led to the photodetector 28 as a defocused beam.

In this case, as shown in FIG. 8C, the crosstalk light is radiated to the photodetector 28 as a concentrically magnified condense spot with respect to the signal light. The crosstalk light rides as a noise component on the signal as an optical beam from the information recording layer 5, and becomes so-called interlayer crosstalk.

In FIG. 8B, the luminous flux of the crosstalk light becomes convergent light after passing the objective lens 25. Alternatively, as in FIG. 8A, the crosstalk light becomes a defocused beam on the photodetector 28, and generates a concentrically magnified condense spot with respect to the condense spot of the signal light.

As described above, when recording or reproducing information on/from a two-layer optical disc, a condense spot of crosstalk light is generated on a photodetector as a concentrically magnified light beam with respect to a condense spot of a signal light.

The condense spot 114 shown in FIG. 6 is crosstalk light corresponding to the condense spot 111 of a signal light as the main beam. Similarly, the spots 115 to 112, 124 to 121, 125 to 122, 134 to 131, and 135 to 132 are condense spots corresponding to the signal light and crosstalk light.

There is a noticeable point. A condense spot is doughnut-shaped, because the central part is separated from a light beam passing through the peripheral edge portion of the diffraction pattern 31 of the diffraction optical element 26, as described above.

Thus, for example, the condense spot 111 is shaped to go into the circular gap at the center of the defocused crosstalk light 114. Namely, the condense spots 111 and 114 do not have an overlapping part.

These condense spots are usually beams having an optical path difference within a coherent length defined by the wavelength of a laser beam output from the light source 20. When they are overlapped, they interfere each other generating a noise component different from an original signal, generating relatively large interlayer crosstalk.

In the configuration of this embodiment, the above-mentioned interlayer crosstalk can be largely decreased. A circular gap at the center of a condense spot is preferably larger from the viewpoint of decreasing crosstalk. In this case, a central gap of a signal light is proportionally increased, and causes deterioration of a signal component.

Therefore, the ratio of r1 to r0 shown in FIG. 4, that is, the ratio of the radius of the central circular part to the condense spot diameter is preferably
r1/r0=0.15.

In the embodiment shown in FIG. 6, the size and interval of each light-receiving part are defined, so that the optical spot 114 of crosstalk of a main beam is not laid on the light-receiving parts 123 and 133 for a sub beam.

Namely, since a main beam usually has the strength of 10 times or more of a sub beam, when crosstalk light of a main beam is laid on the light-receiving part for a sub beam, a sub beam signal is largely influenced.

Therefore, as in the embodiment shown in FIG. 6, by the arrangement that a crosstalk component of a main beam optical spot is not laid on the light-receiving arts 123 and 133 for a sub beam, a crosstalk to sub beam by the optical spot 114 by a crosstalk of main beam can be decreased.

In addition to the above TES, an HF (reproduce) signal and a focus error signal are generated from the output of the photodetector 28 by the arithmetic circuit 12 (refer to FIG. 2).

The objective lens 25 can be moved by the actuator 29 in the vertical direction in FIG. 2, or in the direction of closing to/separating away from the recording surface of an optical disc, and in the disc radial direction (in the lateral direction of an optical disc in FIG. 2), and is controlled by the servo circuit 13 so that an optical beam is always condensed at the center of an information track on the optical disc 1.

In FIG. 2, the diffraction optical element 26 is placed also in the stage after the polarization beam splitter 23, but not limited in the position as long as it is placed in a stage after the objective lens 25 on the optical path of the reflected light 101. For example, the diffraction optical element may be placed immediately after the objective lens 25, contained in the same barrel as the objective lens 25, and changed the position together with the objective lens 25. Particularly, in this case, the center of the diffraction optical element 26 is not displaced from the aperture center of the objective lens 25.

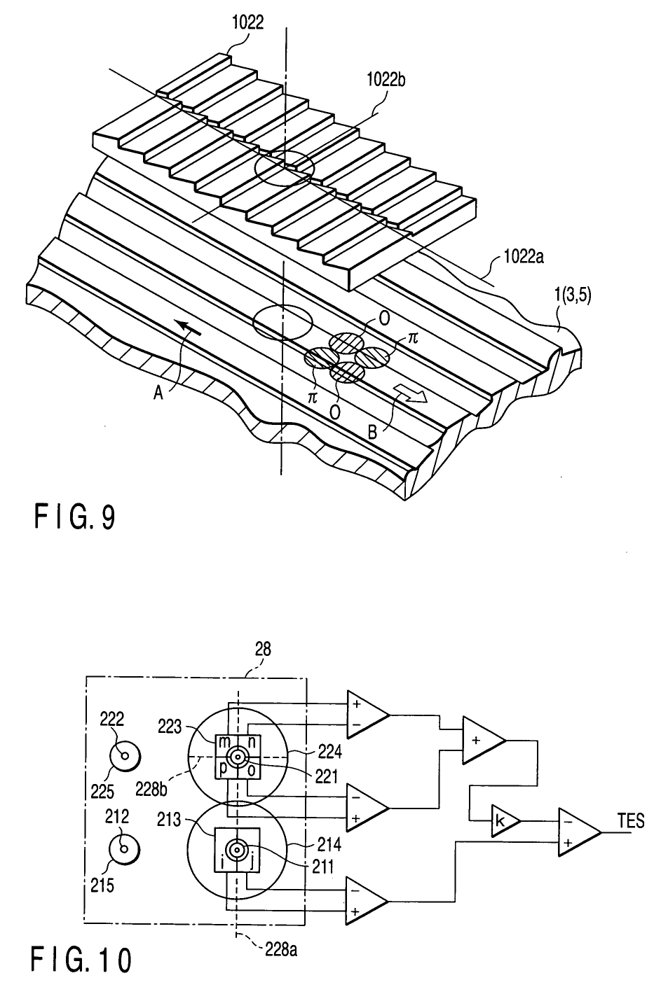

FIG. 9 explains another embodiment using a diffraction grating different from the one shown in FIG. 3 in the optical head unit shown in FIG. 2. In FIG. 9, detailed explanation will be omitted for the same configuration as the optical head unit shown in FIG. 2.

The diffraction grating 1022 shown in FIG. 9 can generate only 0th-order light and +1st-order diffraction light as a condense spot on the recording layer 5 (3) on the optical disc 1. In this case, a diffraction pattern is designed so that a sub beam (+1st-order light) is placed ahead of a main beam (0th-order light) in the optical beam scanning direction. Namely, the diffraction grating 1022 is given a diffraction pattern capable of forming a sub beam (four diffraction components) in the direction of the arrow B reverse to the direction of the arrow A to rotate the optical disc 1. In other words, the diffraction grating 1022 can intensively generate sub beams (diffraction components) near a non-diffracted component (main beam) in the upstream side of the direction of rotating the optical disc 1, with respect to the main beam condensed on a track of the optical disc 1.

With the diffraction grating 1022 shown in FIG. 9, the intensity of even a sub beam used for the DPP system may reach the intensity similar to the level of erasing a record mark recorded immediately before, according to the demand for increasing the optical disc recording speed, as long as a sub beam generated from a laser beam used for information recording is used. As a result, this eliminates a possibility that a mark formed by a main beam for recording a data mark is erased by a sub beam by mistake.

In particular, with the diffraction grating 1022 shown in FIG. 9, the luminous flux of +1st-order diffraction light is divided into four parts, and the phase difference between the adjacent optical beams (sub beams) is π.

Namely, the diffraction grating 1022 is divided into four parts by a partition line 1022a parallel to the tangential direction of a track of the optical disc 1 and a partition line 1022b orthogonal to the line 1022.

The phase of the grating is inverted in the adjacent cells divided into four parts by the partition lines 1022a and 1022b. Thus, diffraction light diffracted by each cell of the diffraction grating 1022 becomes a luminous flux with the phase displaced by π in the adjacent elements (cells).

In the diffraction grating 1022 shown in FIG. 9, each cell (diffraction element) is a blaze grating, and only two beams of 0th-order light and +1st-order light are obtained (four optical spots, because the diffraction grating 1022 is divided into four parts).

Thought not described in detail, the optical beam 100 emitted from the laser light source 20 passes through the diffraction grating 1022, and condensed on the recording surface 5 (3) of the optical disc 1 by the objective lens 25, and reflected. The reflected optical beam is reflected by the polarization beam splitter 23 toward the diffraction optical element 26, and divided into a diffraction beam of the central part diffracted and a non-diffracted light beam passing through the peripheral part, and focused as an image on the light-receiving surface of a photodetector, as shown in FIG. 5.

As shown in FIG. 10, the condense spots 211 and 212 corresponding to a main beam (0th-order light) and the condense spots 221 and 222 corresponding to a sub beam (+1st-order diffraction light) are focused as images on the light-receiving surface of a photodetector. These condense spots form image on a two-divided light receiving part 213 and a four-divided light receiving part 223.

The two-divided light-receiving part 213 is divided into two parts by a partition line 228a (corresponding to the partition line 1022a in FIG. 9) corresponding to the direction parallel to a track of the optical disc 1. The four-divided light-receiving part 223 is divided into four parts by two partition lines 228a and 228b (corresponding to the partition lines 1022a and 1022b in FIG. 9) corresponding to the direction parallel to a track of the optical disc 1 and vertical in the disc surface.

Reference characters i and j indicate the left and right cells of the two-divided light-receiving part 213, m, n, o and p from the upper left clockwise indicate the four cells of the four-divided light-receiving part 223. Each cell outputs a current corresponding to the light intensity of an optical beam radiated (condensed) to that cell. The output current is converted to a voltage by a not-shown I/V conversion amplifier, and becomes a voltage output.

Assuming the voltage output signals obtained from the cells i to p to be Si, Sj, Sm to Sp, a tracking error signal TES as a DPP signal is obtained by the following equation in the arithmetic circuit in FIG. 10.
TES=(Si−Sj)−k(Sm−Sn+Sp−So)

According to the DPP (TES) signal, when the objective lens 25 is shifted in the direction vertical to a track, a signal excluding a usually generated offset is obtained.

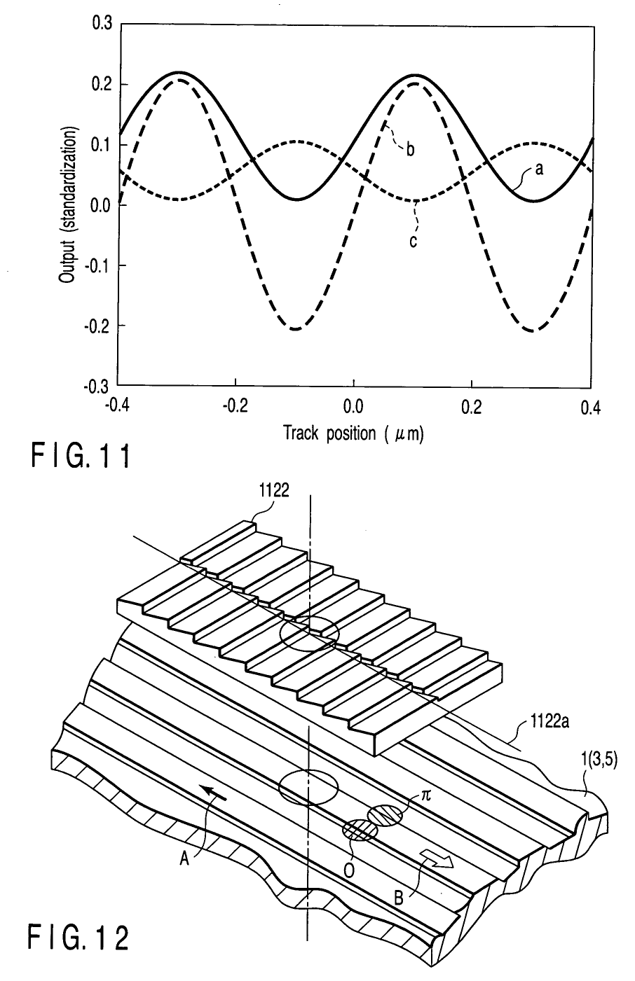

FIG. 11 shows an example of TES output obtained in the signal processing system (arithmetic unit) shown in FIG. 10.

FIG. 11 shows the result of calculation assuming that the wavelength λ of an optical beam emitted from the light source 20 is 405 nm, the numerical aperture NA of the objective lens 25 is 0.65, the track pitch of the optical disc 1 is 0.4 μm and k=1.0, and the lens shift of the objective lens 25 is 150 μm.

As seen from FIG. 11, the ordinary push-pull signal Si−Sj indicated by the curve a generates a large offset, and does not cross a point 0. Likewise, the signal Sm−Sn or Sp−So indicated by the broken line curve c does not cross a point 0.

Contrarily, the TES as an output obtained by the arithmetic circuit shown in FIG. 10 includes little offset as indicated by the broken line curve b. This proves that the optical head unit of this embodiment can provide a DPP signal capable of discriminating a point 0 exactly.

Referring again to FIG. 10, the condense spots 214, 215, 224 and 225 condensed on the light-receiving surface of the photodetector indicate the condense spots when recording or reproducing a two-layer optical disc with 0th-order light and +1st-order diffraction light.

In the example shown in FIG. 10, as in the example shown in FIG. 6, a condense spot of an optical beam passing through the peripheral edge portion of the diffraction pattern 31 of the diffraction optical element 26 is doughnut-shaped. For example, the condense spot 211 is shaped to go into the circular gap at the center of the defocused crosstalk light 214. Namely, the condense spots 211 and 214 do not have an overlapping part, and do not generate interlayer crosstalk caused by an interference of signal light and crosstalk light.

As explained in FIG. 6, the circular gap at the center of a condense spot is preferably large from the viewpoint of decreasing crosstalk. However, in this case, a central gap of a signal light is proportionally increased, and causes deterioration of a signal component. Therefore, the ratio of r1 (diffraction area diameter) to r0 (optical spot diameter) of the diffraction optical element 26 shown in FIG. 4 is preferably
r1/r0=0.15.

In the embodiment shown in FIG. 10, the size and interval of each light-receiving part are defined, so that the optical spot 214 of crosstalk of a main beam is not laid on the light-receiving part 223 for a sub beam. Namely, in the detection system shown in FIG. 10, crosstalk to sub beam by the optical spot 214 by a crosstalk of main beam can be decreased.

FIG. 12 explains another embodiment using a diffraction grating different from the one shown in FIG. 3 and FIG. 9 in the optical head unit shown in FIG. 2. In FIG. 12, detailed explanation will be omitted for the same configuration as the optical head unit shown in FIG. 2.

The diffraction grating 1122 shown in FIG. 12 can generate only 0th-order light and +1st-order diffraction light as a condense spot on the recording layer 5 (3) on the optical disc 1. In this case, a diffraction pattern is designed so that a sub beam (+1st-order light) is placed ahead of a main beam (0th-order light) in the optical beam scanning direction, as in the embodiment shown in FIG. 9. The diffraction grating 1122 is given a diffraction pattern capable of forming a sub beam (two diffraction components) in the direction of the arrow B reverse to the direction of the arrow A to rotate the optical disc 1. In other words, the diffraction grating 1122 can intensively generate sub beams (diffraction components) near a non-diffracted component (main beam) in the upstream side of the direction of rotating the optical disc 1, with respect to the main beam condensed on a track of the optical disc 1.

With the diffraction grating 1122 shown in FIG. 12, a possibility that a mark formed by a main beam for recording a data mark is erased by a sub beam by mistake, is eliminated, as in the embodiment of FIG. 9.

In particular, with the diffraction grating 1122 shown in FIG. 12, the luminous flux of +1st-order diffraction light is divided into two parts, and the phase difference between the adjacent optical beams (sub beams) is π.

Namely, the diffraction grating 1122 is divided into two parts by a partition line 1122a parallel to the tangential direction of a track of the optical disc 1. 125

The phase of the grating is inverted in the adjacent cells divided into two parts by the partition lines 1122a. Thus, a diffraction light diffracted by each cell of the diffraction grating 1122 becomes a luminous flux with the phase displaced by π each other.

In the diffraction grating 1122 shown in FIG. 12, each cell (diffraction element) is a blaze grating, and only two beams of 0th-order light and +1st-order light are obtained (two optical spots, because the diffraction grating 1122 is divided into two parts).

Thought not described in detail, the optical beam 100 emitted from the laser light source 20 passes through the diffraction grating 1122, and condensed on the recording surface 5 (3) of the optical disc 1 by the objective lens 25, and reflected. The reflected optical beam is reflected by the polarization beam splitter 23 toward the diffraction optical element 26, and divided into a diffraction beam of the central part diffracted and a non-diffracted light beam passing through the peripheral part, and focused as an image on the light-receiving surface of a photodetector, as shown in FIG. 5.

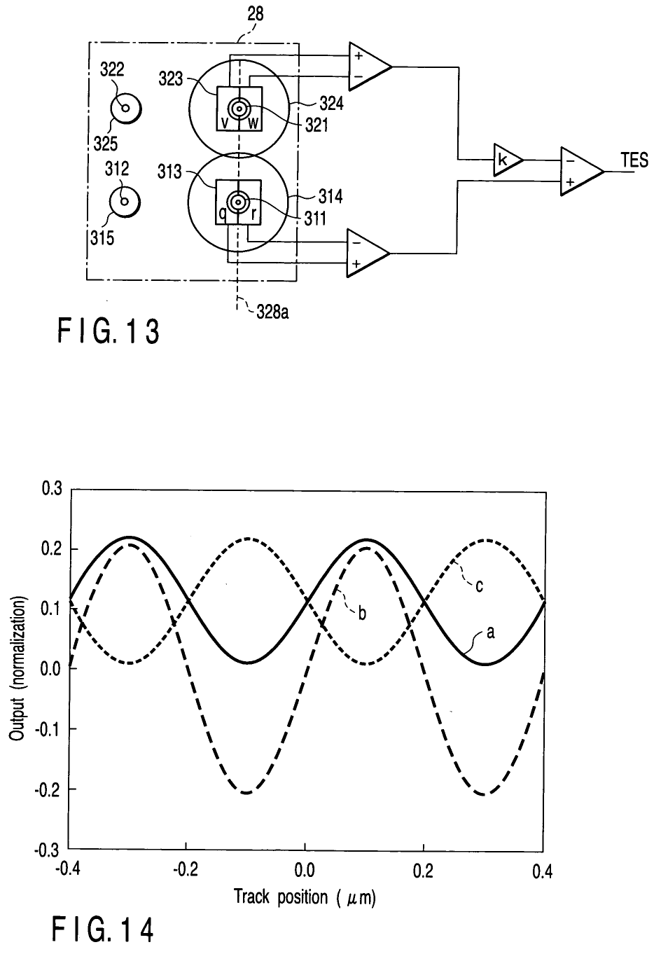

As shown in FIG. 13, the condense spots 311 and 312 corresponding to a main beam (0th-order light) and the condense spots 321 and 322 corresponding to a sub beam (+1st-order diffraction light) are focused as images on the light-receiving surface of a photodetector. These condense spots form image on two-divided light receiving parts 313 and 323.

The two-divided light-receiving parts 313 and 323 are divided into two parts by a partition line 328a (corresponding to the partition line 1122a in FIG. 12) corresponding to the direction parallel to a track of the optical disc 1.

Reference characters q and r indicate the left and right cells of the two-divided light-receiving part 313, v and w indicate the left and right cells of the two-divided light-receiving part 323. Each cell outputs a current corresponding to the light intensity of an optical beam radiated (condensed) to that cell. The output current is converted to a voltage by a not-shown I/V conversion amplifier, and becomes a voltage output.

Assuming the voltage output signals obtained from the cells q, r, v and w to be Sq, Sr, Sv and Sw, a tracking error signal TES as a DPP signal is obtained by the following equation in the arithmetic circuit in FIG. 13.
TES=(Sq−Sr)−k(Sv−Sw)

According to the DPP (TES) signal, when the objective lens 25 is shifted in the direction vertical to a track, a signal excluding a usually generated offset is obtained.

FIG. 14 shows an example of TES output obtained in the signal processing system (arithmetic unit) shown in FIG. 13.

FIG. 14 shows the result of calculation assuming that the wavelength λ of an optical beam emitted from the light source 20 is 405 nm, the numerical aperture NA of the objective lens 25 is 0.65, the track pitch of the optical disc 1 is 0.4 μm and k=1.0, and the lens shift of the objective lens 25 is 150 μm.

As seen from FIG. 14, the ordinary push-pull signal Sq−Sr indicated by the curve a generates a large offset, and does not cross a point 0. Likewise, the signal Sv−Sw indicated by the broken line curve c does not cross a point 0.

Contrarily, the TES as an output obtained by the arithmetic circuit shown in FIG. 13 includes little offset as indicated by the broken line curve b. This proves that the optical head unit of this embodiment can provide a DPP signal capable of discriminating a point 0 exactly.

Referring again to FIG. 13, the condense spots 314, 315, 324 and 325 condensed on the light-receiving surface of the photodetector indicate the condense spots when recording or reproducing a two-layer optical disc with 0th-order light and +1st-order diffraction light.

In the example shown in FIG. 13, as in the example shown in FIG. 6 and FIG. 10, a condense spot of an optical beam passing through the peripheral edge portion of the diffraction pattern 31 of the diffraction optical element 26 is doughnut-shaped. For example, the condense spot 311 is shaped to go into the circular gap at the center of the defocused crosstalk light 314. Namely, the condense spots 311 and 314 do not have an overlapping part, and do not generate inter-layer crosstalk caused by interference of signal light and crosstalk light.

As explained in FIG. 6 and FIG. 10, the circular gap at the center of a condense spot is preferably large from the viewpoint of decreasing crosstalk. However, in this case, a central gap of a signal light is proportionally increased, and causes deterioration of a signal component. Therefore, the ratio of r1 (diffraction area diameter) to r0 (optical spot diameter) of the diffraction optical element 26 shown in FIG. 4 is preferably
r1/r0=0.15.

In the embodiment shown in FIG. 13, the size and interval of each light-receiving part are defined, so that the optical spot 314 of crosstalk of a main beam is not laid on the light-receiving part 323 for a sub beam. Namely, in the detection system shown in FIG. 13, crosstalk to sub beam by the optical spot 314 by a crosstalk of main beam can be decreased.

In the detection systems shown in FIG. 6, FIG. 10 and FIG. 13, the photodetector 28 does not have a light-receiving part corresponding to the condense spot diffracted by the central diffraction pattern 31 of the diffraction optical element 26, but another light-receiving part corresponding to such a condense spot may be provided.

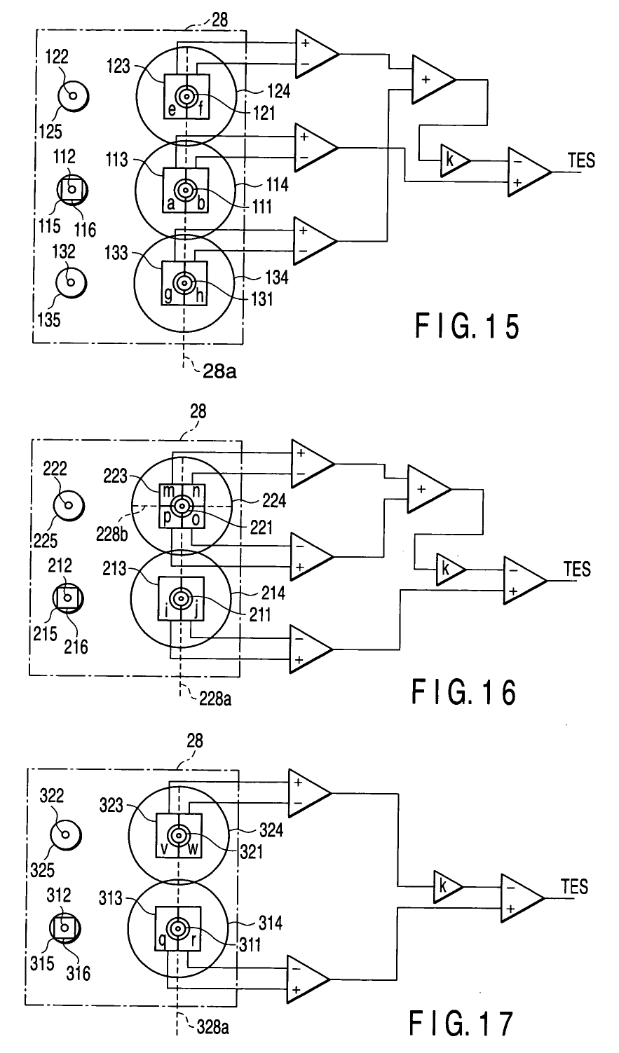

For example, a photodetector may be configured as shown in FIG. 15, by providing a light-receiving part 116 for the condense spot 122 in FIG. 6. In this case, the total light-receiving amount of a main beam used for data reproduce can be increased by detecting a signal by a main beam from both light-receiving parts 113 and 116, and the signal detection sensitivity can be increased.

Similarly, a photodetector may be configured as shown in FIG. 16, by providing a light-receiving part 116 for the condense spot 212 in FIG. 10. In this case, the total light-receiving amount of a main beam used for data reproduce can be increased by detecting a signal by a main beam from both light-receiving parts 213 and 116, and higher signal detection sensitivity is possible (the ratio of a signal component to a noise component of a detection signal is improved).

Similarly, a photodetector may be configured as shown in FIG. 17, by providing a light-receiving part 316 for the condense spot 312 in FIG. 13. Of course, in this case, the total light-receiving amount of a main beam used for data reproduce can be increased by detecting a signal by a main beam from both light-receiving parts 313 and 316, and higher signal detection sensitivity is possible (the ratio of a signal component to a noise component of a detection signal is improved).

As explained hereinbefore, by using the light-receiving optics of the invention, an interlayer crosstalk can be decreased when recording or reproducing information on/from a two-layer disc.

In the 3-beam detection system for detecting a DPP signal, stable tracking control is possible regardless of a track pitch, that is, in an optional track of an optical disc having tracks with 2 or more track pitches.

Further, a DPP signal can be detected by 2 beams in the DPP signal detection system, and the number of light-receiving elements is decreased and the cost is decreased. At the same time, the whole area of the light-receiving surface of a photodetector is reduced, and a noise is decreased.

A sub beam is radiated only to ahead of the direction a main beam scans a disc, or in front of a main beam with respect to the optical disc rotating direction. This eliminates a possibility that a sub beam is radiated to a record mark immediately after recording information, for example, and a record mark becomes unstable (a record mark is erased).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, an optical disc apparatus is taken as an example in the detailed explanation of embodiments. But, the invention is of course applicable widely for A movie camera using an optical disc as a recording media, and a portable audio equipment to contain musical data.

What is claimed is:

1. An optical head unit comprising:
an objective lens which condenses light from a light source to one of recording layers of a recording medium having at least two recording layers;
a diffraction element which generates a non-diffracted component passing through as it is and ±1st-order diffraction components near the non-diffracted component, from light passed through the objective lens and condensed to a recording layer of the recording medium;
an optical element which divides light reflected on one of the recording layers of the recording medium and captured by the objective lens, into a first luminous flux passing the center and near of the objective lens and a second luminous flux passing the outside the first luminous flux;
a photodetector which has several detection areas, receives at least one of the first and second luminous flux separated by the optical element, and outputs an electric signal corresponding to the intensity of the luminous flux; and
a signal processing circuit which eliminates an offset component in the direction orthogonal to a guide groove peculiar to the recording surface of the recording medium, from the output of the photodetector.

2. The optical head unit according to claim 1, wherein the diffraction element has a grating pattern capable of providing two pairs of optical spots each having inverted phases of a 1st-order diffraction component and a −1st-order diffraction component on the same guide groove on the recording medium to which the non-diffracted component is condensed.

3. The optical head unit according to claim 1, wherein when the optical element divides the light captured by the objective lens into the first and second luminous flux, the radius of the first luminous flux is defined to a maximum of 0.15 times of the radius of the second luminous flux.

4. The optical head unit according to claim 2, wherein when the optical element divides the light captured by the objective lens into the first and second luminous flux, the radius of the first luminous flux is defined to a maximum of 0.15 times of the radius of the second luminous flux.

5. The optical head unit according to claim 1, wherein the diffraction element includes a binary type diffraction grating, which is divided into two parts by a separating line which lies in the direction parallel to the guide groove peculiar to the recording medium, in the state projected on the recording medium.

6. An optical head unit comprising:
an objective lens which condenses light from a light source to one of recording layers of a recording medium having at least two recording layers;
a diffraction element which generates a non-diffracted component passing through as it is and generates diffracted components intensively near the non-diffracted component, from light passed through the objective lens and condensed to a recording layer of the recording medium;
an optical element which divides light reflected on one of the recording layers of the recording medium and captured by the objective lens, into a first luminous flux passing the center and near of the objective lens and a second luminous flux passing the outside the first luminous flux;
a photodetector which has several detection areas, receives at least one of the first and second luminous flux separated by the optical element, and outputs an electric signal corresponding to the intensity of the luminous flux; and
a signal processing circuit which eliminates an offset component in the direction orthogonal to a guide groove peculiar to the recording surface of the recording medium, from the output of the photodetector.

7. The optical head unit according to claim 6, wherein the diffraction element has a grating pattern capable of providing two pairs of two optical spots each having inverted phases of each of the two pairs of the diffracted components, on the same guide groove on the recording medium to which the non-diffracted component is condensed, and in the upstream side of the direction of rotating the recording medium with respect to the position where the non-diffracted component is condensed.

8. The optical head unit according to claim 6, wherein when the optical element divides the light captured by the objective lens into the first and second luminous flux, the radius of the first luminous flux is defined to a maximum of 0.15 times of the radius of the second luminous flux.

9. The optical head unit according to claim 7, wherein the diffraction element includes a blaze type diffraction grating, which is divided into four parts in the directions parallel to and orthogonal to the guide groove peculiar to the recording medium, in the state projected on the recording medium.

10. The optical head unit according to claim 7, wherein when the optical element divides the light captured by the objective lens into the first and second luminous flux, the radius of the first luminous flux is defined to a maximum of 0.15 times of the radius of the second luminous flux.

11. The optical head unit according to claim 6, wherein the diffraction element has a grating pattern capable of providing a pair of two optical spots each having inverted phases of each of the pairs of the diffracted components, on the same guide groove on the recording medium to which the non-diffracted component is condensed, and in the upstream side of the direction of rotating the recording medium with respect to the position where the non-diffracted component is condensed.

12. The optical head unit according to claim 11, wherein when the optical element divides the light captured by the objective lens into the first and second luminous flux, the radius of the first luminous flux is defined to a maximum of 0.15 times of the radius of the second luminous flux.

13. The optical head unit according to claim 11, wherein the diffraction element includes a blaze type diffraction grating, which is divided into four parts in the directions parallel to and orthogonal to the guide groove peculiar to the recording medium, in the state projected on the recording medium.

14. An optical disc apparatus comprising:
an objective lens which condenses light from a light source to one of recording layers of a recording medium having at least two recording layers; a diffraction element which generates a non-diffracted component passing through as it is and +1st-order diffraction components near the non-diffracted component, from light passed through the objective lens and condensed to a recording layer of the recording medium; an optical element which divides light reflected on one of the recording layers of the recording medium and captured by the objective lens, into a first luminous flux passing the center and near of the objective lens and a second luminous flux passing the outside the first luminous flux; a photodetector which has several detection areas, receives at least one of the first and second luminous flux separated by the optical element, and outputs an electric signal corresponding to the intensity of the luminous flux; and a signal processing circuit which eliminates an offset component in the direction orthogonal to a guide groove peculiar to the recording surface of the recording medium, from the output of the photodetector; and
a signal processing unit which reproduces information recorded on the recording medium, from the first luminous flux separated by the optical element.
